(19) United States
(12) Patent Application Publication
(10) Pub. No.: US 2015/0026109 A1
(43) Pub. Date: Jan. 22, 2015

(54) METHOD AND SYSTEM FOR PREDICTING POWER CONSUMPTION

(71) Applicant: Electronics and Telecommunications Research Institute, Daejeon (KR)

(72) Inventors: Jongjun PARK, Daejeon (KR); Hyunhak KIM, Daejeon (KR); Tae-Wook HEO, Sejong-si (KR); JeongGil KO, Daejeon (KR); Seung-mok YOO, Daejeon (KR); Nae-Soo KIM, Daejeon (KR)

(73) Assignee: Electronics and Telecommunications Research Institute, Daejeon (KR)

(21) Appl. No.: 14/332,968

(22) Filed: Jul. 16, 2014

(30) Foreign Application Priority Data
Jul. 16, 2013 (KR) 10-2013-0083792

(51) Int. Cl. G06N 5/04; G06N 3/02

(52) U.S. Cl. CPC G06N 5/04; G06N 3/02
USPC 706/21; 706/46

(57) ABSTRACT

In order to predict power consumption, previous measurements, which indicate the actual amount of power consumed in the past, and errors between previous estimates and the previous measurements, are used as first input data, and power consumption estimates for each prediction technique are simultaneously calculated by using the first input data in at least two prediction techniques. Next, the power consumption estimates calculated by each prediction technique and errors between the power consumption estimates and an actual measurement are used as second input data, and the final power consumption is predicted by making an additional power consumption prediction based on the second input data.

### CROSS-REFERENCE TO RELATED APPLICATION

This application claims priority to and the benefit of Korean Patent Application No. 10-2013-0083792 filed in the Korean Intellectual Property Office on Jul. 16, 2013, the entire contents of which are incorporated herein by reference.

### BACKGROUND OF THE INVENTION

(a) Field of the Invention

The present invention relates to a method and system for predicting power consumption.

(b) Description of the Related Art

With the depletion of fossil energy resources, research on energy optimization and energy saving has been actively carried out all over the world. For large buildings, research into energy management techniques which can maintain user satisfaction with buildings they occupy and save on energy costs for air conditioning by operating an air-conditioning system while considering weather prediction information, temperature changes in the buildings, the structures of the buildings, and so on, together, is actively in progress. Recently, research has been conducted into new techniques aimed at saving on energy costs by predicting future energy consumption based on past energy consumption, and using the prediction in energy management. In these energy management techniques based on prediction, performance depends largely on prediction accuracy, so there is a need for very accurate energy consumption prediction techniques.

Because the energy consumption of a city or county is closely related to weather, research has been conducted on the prediction of large-scale energy consumption of a city or county using weather information and control of electricity generation based on energy consumption prediction. On the other hand, the energy consumption of a single building, particularly a house, is affected greatly by the lifestyle patterns of people living in the house, as well as by weather. Accordingly, household energy consumption is more independent of external factors such as time and weather, as well as the energy consumption of other houses, and it is more difficult to predict than large-scale energy consumption.

Conventional prediction techniques involve predicting future energy consumption by machine learning based on past energy consumption. As mentioned above, however, household energy consumption reacts unexpectedly to changes in the home environment (e.g., purchase of new electrical equipment, a vacation, a move, etc.), and these sudden changes are hard to predict.

In the case of a prediction technique using an NLMS (normalized least mean square) filter, this filter makes a relatively accurate prediction when energy consumption is stable, and quickly follows predicted values even when a sudden change occurs. However, this technique has the drawback of making excessive predictions caused by overfitting if sudden changes repeatedly occur.

In addition, a Kalman filter makes a relatively stable prediction of energy consumption, but it does not react quickly to sudden changes and it is important to correctly select a filter coefficient.

Recently, neural networks, which are frequently used for energy prediction, have shown relatively good performance, even with non-linear changes. However, when initially building a neural network, it is necessary to properly select artificial parameters, such as the number of hidden layers, and training samples. Also, repeated sudden changes can result in local optimization or overfitting.

### SUMMARY OF THE INVENTION

The present invention has been made in an effort to provide a method and system for accurately predicting power consumption by adaptively using a plurality of energy prediction techniques.

An exemplary embodiment of the present invention provides a method for predicting power consumption, the method including: using, as first input data, previous measurements, which indicate the actual amount of power consumed in the past, and errors between previous estimates and the previous measurements; simultaneously calculating power consumption estimates for each prediction technique by using the first input data in at least two prediction techniques; using, as second data, the power consumption estimates calculated by each prediction technique and errors between the power consumption estimates and an actual measurement; and predicting the final power consumption by making an additional power consumption prediction based on the second input data.

The calculating of power consumption estimates for each prediction technique includes: predicting power consumption based on the first input data by using an NLMS (normalized least mean square) filter; predicting power consumption based on the first input data by using a Kalman filter; and predicting power consumption based on the first input data by using a neural network.

The predicting of the final power consumption includes either one of the following: predicting power consumption based on the second input data by using a weighted average method; and predicting power consumption based on the second input data by using a neural network.

In the predicting of power consumption by using the weighted average method, different weighted values are assigned to the second input data depending on the prediction techniques, and power consumption is predicted based on the second input data to which the different weighted values are assigned.

The weighted values assigned to the second input data for each prediction technique may differ depending on the environmental parameters of an environment where power consumption is predicted.

Another exemplary embodiment of the present invention provides a system for predicting power consumption, the system including: a first layer prediction that uses, as first input data, previous measurements, which indicate the actual amount of power consumed in the past, and errors between previous estimates and the previous measurements, and simultaneously calculates power consumption estimates for each prediction technique by using the first input data in at least two prediction techniques; an error calculator that calculates errors between the power consumption estimates calculated by each prediction technique and an actual measurement; and a second layer predictor that uses, as second data, the power consumption estimates calculated by each prediction technique and the errors output from the error calculator, and predicts the final power consumption by making an additional power consumption prediction based on the second input data.

The first layer predictor includes: a first predictor that predicts power consumption based on the first input data by using an NLMS (normalized least mean square) filter; a second predictor that predicts power consumption based on the first input data by using a Kalman filter; and a third predictor that predicts power consumption based on the first input data by using a neural network.

The second layer predictor assigns different weighted values to the second input data depending on the prediction techniques, and predicts power consumption based on the second input data to which the different weighted values are assigned.

The second layer predictor may vary the weighted values assigned to the second input data for each prediction technique depending on the environmental parameters of an environment where power consumption is predicted.

The second layer predictor may predict power consumption based on the second input data by using a neural network.

### BRIEF DESCRIPTION OF THE DRAWINGS

FIG. 1 is a view showing the concept of a filter based prediction technique using an adaptive compensation filter according to an exemplary embodiment of the present invention.

FIG. 2 is a conceptual view of a neural network based prediction method using a neural network according to a second exemplary embodiment of the present invention.

FIG. 3 is a view showing the structure of a system for predicting power consumption according to an exemplary embodiment of the present invention.

FIG. 4 is a conceptual view of a method for predicting power consumption according to an exemplary embodiment of the present invention.

FIG. 5 is a flowchart of a method for predicting power consumption according to an exemplary embodiment of the present invention.

FIG. 6 is a view showing the structure of a system for predicting power consumption according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Now, a method and system for predicting power consumption according to an exemplary embodiment of the present invention will be described.

The exemplary embodiment of the present invention aims to optimally and accurately predict power consumption by adaptively using a plurality of energy prediction techniques.

The energy (e.g., power consumption) prediction techniques according to the exemplary embodiment of the present invention include a prediction technique (for convenience of explanation, it will be referred to as a filter based prediction technique) using an adaptive compensation filter and a prediction technique for predicting power consumption with a neural network (for convenience of explanation, it will be referred to as a neural network based prediction technique). However, the energy prediction techniques according to the exemplary embodiment of the present invention are not restricted to thereto.

The filter based prediction technique predicts power consumption by an adaptive compensation filter. The adaptive compensation filter may be, but is not limited to, an LMS (least mean square) filter or a Kalman filter.

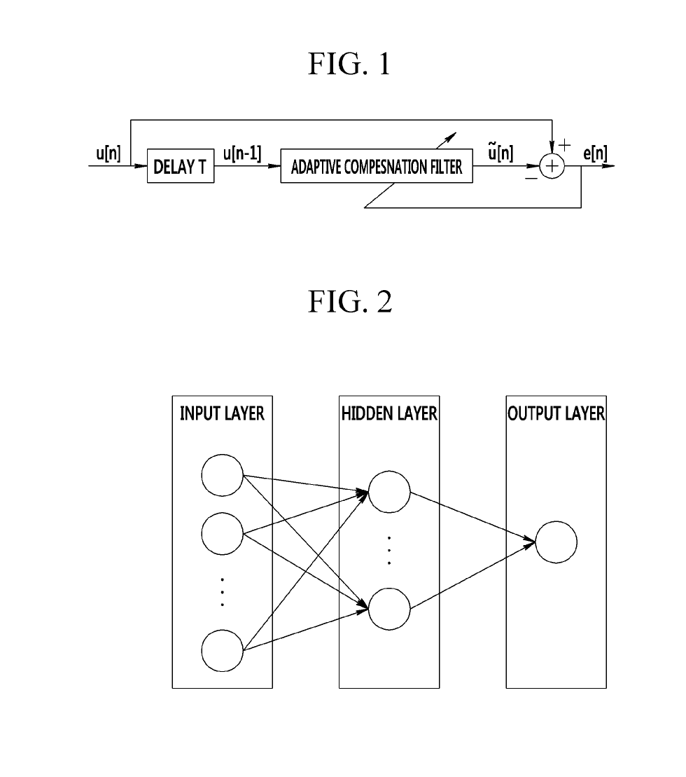

FIG. 1 is a view showing the concept of a filter based prediction technique using an adaptive compensation filter according to an exemplary embodiment of the present invention.

As shown in the attached FIG. 1, an adaptive compensation filter is used to delay input data (u[n]) by one step and process and output it.

This filter is one of the filters that show optimal performance for ARMA (auto-regressive moving average) models. The ARMA model predicts power consumption by an AR (auto-regression) process and an MA (moving average) process. The AR process uses previous measurements, which indicate the amount of power actually consumed in the past, and the MA process uses errors between previous estimates, which indicate the amount of power consumption predicted in the past, and previous measurements.

Meanwhile, the Kalman filter is used in the control field and in a variety of fields using time-series data. The Kalman filter acquires the best predicted value based on measurements by which time-series data is represented in a state space model.

The Kalman filter is used in prediction methods which can be applied for nonlinear characteristics, and makes a more stable prediction than the LMS filter.

The neural network based prediction technique uses a neural network.

FIG. 2 is a conceptual view of a neural network based prediction method using a neural network according to a second exemplary embodiment of the present invention.

As shown in the attached FIG. 2, the neural network based prediction technique using a neural network uses three layers of an input layer, a hidden layer, and an output layer. According to an exemplary embodiment of the present invention, previous measurements and errors between previous estimates and previous measurements can be fed into the input layer. Data fed into the input layer passes through the hidden layer, and the resulting data is output through the output layer. In the filter based prediction technique using an LMS filter, which is used in the exemplary embodiment of the present invention, the prediction performance for nonlinear characteristics is low. For example, household energy consumption shows nonlinear characteristics, so a linear prediction technique such as the LMS cannot guarantee the optimum prediction performance.

Meanwhile, the filter based prediction technique using a Kalman filter cannot quickly respond to rapid changes like the LMS, and its characteristics may change according to which coefficient is selected in designing the system.

In addition, the neural network based prediction technique using a neural network shows relatively excellent prediction performance in spite of the nonlinearity of data. However, the number of hidden layers in the neural network needs to be arbitrarily selected, and the components of the network also need to be arbitrarily selected, which causes the performance to vary greatly.

In the exemplary embodiment of the present invention, power consumption estimates are made by using all of these prediction techniques together, and the weighted average is added to the power consumption estimates made by these methods, taking the characteristics of these prediction techniques into account, or additional neural networks are configured, and the final power consumption is predicted. In the exemplary embodiment of the present invention, power consumption is accurately predicted by adaptively using prediction techniques, taking the merits of each prediction technique into account.

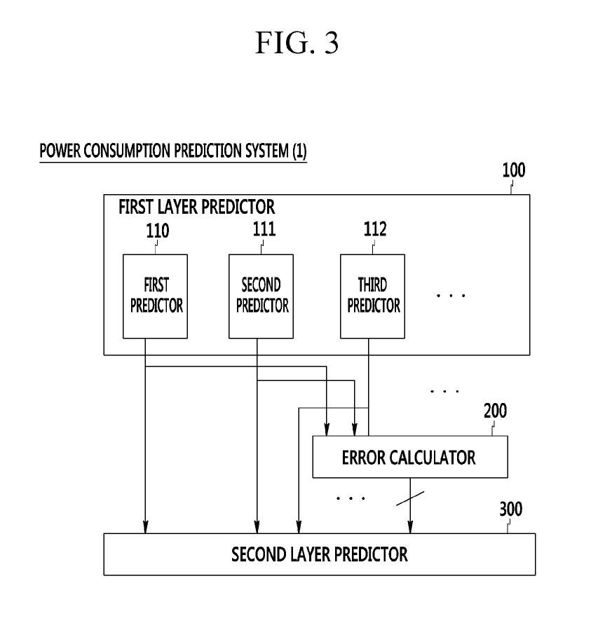

FIG. 3 is a view showing the structure of a system for predicting power consumption according to an exemplary embodiment of the present invention.

As shown in the attached FIG. 3, the power consumption prediction system 1 according to the exemplary embodiment of the present invention includes a first layer predictor 100, an error calculator 200, and a second layer predictor 300, which predict power consumption based on input data by using different prediction techniques.

The first layer predictor 100 includes a plurality of predictors, and the plurality of predictors can be divided into a predictor using the filter based prediction technique and a predictor using the neural network based prediction technique. The predictor using the filter based prediction technique may be plural depending on the type of adaptive compensation filter used. The plurality of predictors included in the first layer predictor 100 include a first predictor 110 that predicts power consumption according to the filter based prediction technique using an NMLS filter, a second predictor 111 that predicts power consumption according to the filter based prediction technique using a Kalman filter, and a third predictor 112 that predicts power consumption according to the neural network based prediction technique using a neural network. However, the predictors according to the exemplary embodiment of the present invention are not limited to these first and third predictors, and the number of predictors may be increased or decreased depending on which adaptive compensation filters or prediction techniques are available in the art. In the exemplary embodiment of the present invention, the plurality of predictors are simultaneously activated, and make predictions based on input data.

Previous measurements, which indicate the amount of power actually consumed in the past, errors between previous estimates, which indicate the amount of power consumption predicted in the past, and previous measurements are provided as input data to each predictor of the first layer predictor 100. Each predictor 110, 111, and 113 predicts power consumption based on previous measurements and errors between previous estimates and previous measurements, and outputs the corresponding predicted values.

The error calculator 200 calculates errors in the predicted values of power consumption, which are predicted by the plurality of predictors 110, 111, and 112. That, the error calculator 200 calculates errors between the predicted values output from each predictor and an actual current measurement.

The second layer predictor 300 predicts power consumption based on the predicted values output from the first layer predictor 100 and the errors output from the error calculator 200, thereby outputting the final power consumption estimate. The second layer predictor 300 uses errors in each prediction technique as input, in the same manner as the preceding layer, i.e., the first layer predictor 100.

The second layer predictor 300 predicts the final power consumption estimate by using a weighted average method for assigning different weighted values to the predicted values output from each predictor.

The weighted values assigned to the predicted values output from each predictor may be different from each other. As predictions are repeatedly made, the weighted values can be adaptively determined according to the prediction results. For example, the weighted value assigned to the predicted values output from each predictor of the first layer predictor can be determined by using the errors between the predicted values obtained in the previous stage and an actual measurement. Specifically, if the errors between the predicted values at [t−1] and the actual measurement are denoted by e_{N}[t−1], e_{K}[t−1], and e_{A}[t−1], the weighted values w_{N}[t], w_{K}[t], and w_{A}[t] for each predicted value can be determined as follows:

w_{N}[t]=(1−e_{N}[t−1]/eₛᵤₘ[t−1])/2

w_{K}[t]=(1−e_{K}[t−1]/eₛᵤₘ[t−1])/2

w_{A}[t]=(1−e_{A}[t−1]/eₛᵤₘ[t−1])/2

where eₛᵤₘ[t−1]=e_{N}[t−1]+e_{K}[t−1]+e_{A}[t−1]). [Equation 1]

Unlike the above description, the weighted values may differ depending on the environmental parameters of an environment where power consumption is predicted. In the environment where power consumption is predicted, for example, when measuring power consumption in a home, the power consumption may vary depending on changes in a home environment. For instance, an increase in power consumption since the purchase of new electronic equipment, a decrease in power consumption when away on vacation, and so on may occur. If there is a sudden change in power consumption associated with a change in environment, the prediction method using an LMS filter for making an accurate prediction when energy consumption is stable, or the prediction method using a Kalman filter that is incapable of quickly reacting to sudden changes, shows low prediction performance. Therefore, the prediction method using a neural network, which provides relatively good prediction performance with nonlinear changes, will be more effective when there is a sudden change in power consumption associated with.

Accordingly, when changes in power consumption are relatively stable, the second layer predictor 300 can assign a higher weighted value to the predicted values output from the first and second predictors 110 and 111 that use the prediction method using an adaptive compensation filter and a lower weighted value to the predicted value output from the third predictor 112 that uses the prediction method using a neural network, taking the changes in power consumption associated with environmental parameters into consideration. On the other hand, when changes in power consumption are nonlinear and sudden, the second layer predictor 300 can assign a lower weighted value to the predicted values output from the first and second predictors 110 and 111 that use the prediction method using an adaptive compensation filter and a higher weighted value to the predicted value output from the third predictor 112 that uses the prediction method using a neural network.

The method of adaptively assigning weighted values according to the present invention is not limited to as above-mentioned.

Meanwhile, the second layer predictor 300 can predict the final power consumption by performing a neural network prediction method using the predicted values output from each predictor of the first layer predictor 100 and the errors output from the error calculator 200. In the neural network prediction method, a final prediction is made by feeding predicted values from a first prediction layer and previous errors between each prediction method into the input layer, in the three-layered neural network of FIG. 2. The neural network as used herein may be an Elman neural network, but the present invention is not limited thereto. The second layer predictor 300 may selectively use the weighted average method or the method using a neural network.

The filter coefficients used in each prediction method by the power consumption prediction system 1 having this structure can be adaptively and automatically set as repetition occurs, with the use of an adaptive compensation structure.

For example, the filter coefficient of an LMS filter can be set as follows. When the LMS filter coefficient h[t]=[h₁[t], h₂[t], . . . , hₚ[t]]^{T}, the predicted values can be found from the result of h[t]x[t−1], (where p should be predetermined by filter size, and x[t−1]=[x[t−1], x[t−2], . . . , x[t−p]]^{T}). The errors between the predicted values obtained in the previous stage and the actual measurement can be represented by e[t]=x[t]−\dot{h}[t]x[t−1], and the filter coefficient can be set as follows.

\dot{h}[t+1]=\dot{h}[t]+μ(e[t]x[t−1]/x^{T}[t−1]x[t−1]) [Equation 2]

An adaptive filter coefficient is set by an NLMS (normalized LMS) technique, and methods for setting the adaptive filter coefficient of an LMS filter are not limited to LMS, NLMS, and VSS (variable step-size) NLMS.

Also, the filter coefficient of a Kalman filter can be set as follows.

$$Prediction \\ {\hat{x}}^{-} [ t ] = A \hat{x} [ t - 1 ] \\ {P}^{-} [ t ] = AP [ t - 1 ] {A}^{T} + Q \\ Measurement \\ K [ t ] = \frac{{P}^{-} [ t ]}{{P}^{-} [ t ] + R} \\ \hat{x} [ t ] = {\hat{x}}^{-} [ t ] + K [ t ] ( x [ t ] - {\hat{x}}^{-} [ t ] ) \\ P [ t ] = ( I - K [ t ] ) {P}^{-} [ t ] \qquad [ Equation 3 ]$$

Unlike the LMS filter, the Kalman filter is a state-based filter. Accordingly, the Kalman filter does not directly update A representing system characteristics, but adaptively updates an input state by using the Kalman filter coefficient K. The technique of updating the state or filter coefficient of the Kalman filter is not limited to as above-mentioned.

Next, a method for predicting power consumption according to an exemplary embodiment of the present invention will be described.

In general, training sample data must be sufficient to reflect total power consumption in order to increase the accuracy of machine learning-based energy prediction. However, household power consumption has no particular pattern, so the conventional machine learning-based energy prediction technique does not show excellent performance in predicting household power consumption. Accordingly, in the exemplary embodiment of the present invention, power consumption prediction is made in a hierarchical manner.

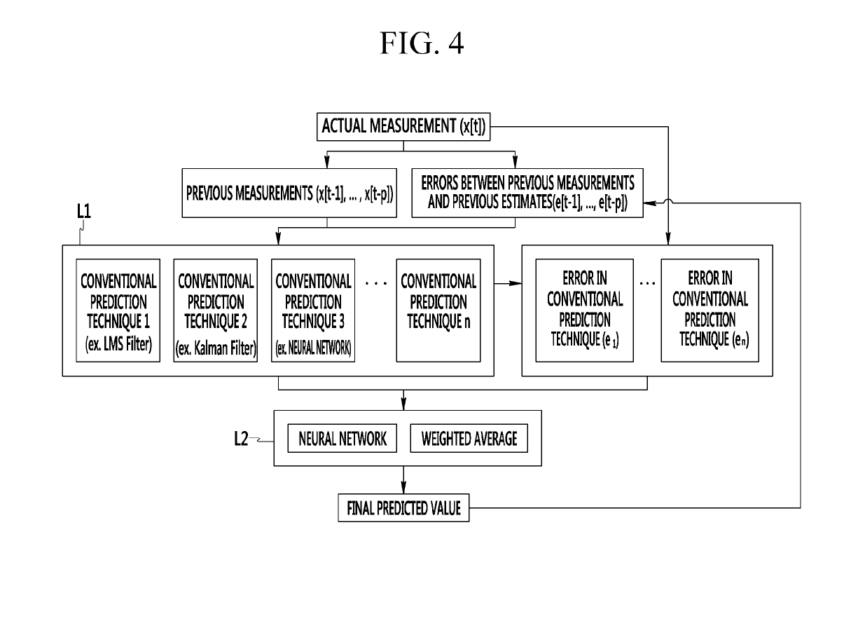

FIG. 4 is a conceptual view of a method for predicting power consumption according to an exemplary embodiment of the present invention.

In the exemplary embodiment of the present invention, a prediction method using two layers is carried out, as shown in FIG. 4. The first layer L1 makes a power consumption prediction by a plurality of different prediction techniques, based on previous measurements and errors between previous estimates and an actual measurement. Also, the second layer L2 makes a final power consumption prediction by using the prediction results of the first layer and the errors in each prediction technique as a weighted value or input into a neural network. The prediction by the second layer can be made by selectively using a weighted value or a neural network.

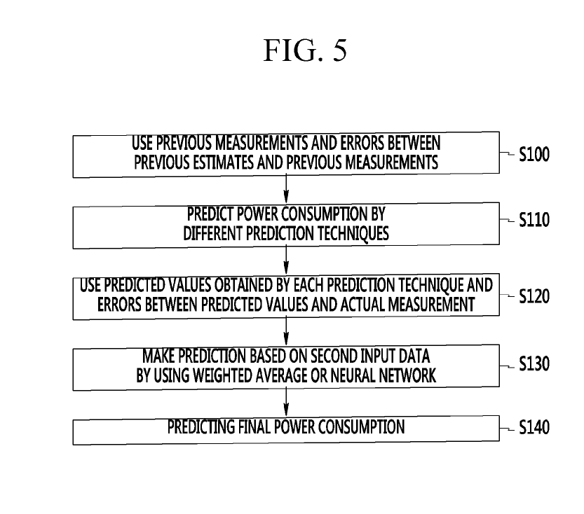

FIG. 5 is a flowchart of a method for predicting power consumption according to an exemplary embodiment of the present invention.

The power consumption prediction system 1 receives previous measurements (x[t−1], . . . , x[t−p]) as inputs, and uses errors (e[t−1], . . . , e[t−p]) between previous estimates and an actual measurement as inputs (S100). This data is used as first input data.

Thereafter, the power consumption prediction system 1 obtains predicted values of power consumption by different prediction techniques, by implementing a plurality of n selected prediction techniques based on input data (S110). These conventional prediction techniques may include the above-mentioned prediction techniques using an NMLS filter, a Kalman filter, a neural network, etc.

The power consumption prediction system 1 uses the predicted values calculated by the respective prediction techniques as input into the next prediction layer.

That is, the predicted values calculated by each prediction technique and the errors (which may be referred to as errors in the prediction techniques) between the predicted values and the actual measurement are used as input data for the next prediction, i.e., second input data (S120). In this case, the power consumption prediction system 1 obtains the predicted values by simultaneously making power consumption predictions for each prediction technique.

In the second prediction layer, the power consumption prediction system 1 obtains the final power consumption by making the final prediction by using a weighted average for each input or using a neural network, in a similar manner to LMS. According to an exemplary embodiment of the present invention, if a weighted average method is used in the second prediction layer, each weighted value assigned for each prediction technique (i.e., a weighted value can be assigned to the predicted values obtained by each prediction technique and the errors between the predicted values and the actual measurement) can be adaptively determined as predictions are repeatedly made. In addition, if a neural network is used in the second prediction layer, the final power consumption is predicted by feeding the predicted values for each prediction technique, obtained in the first layer, and the errors in each prediction technique, into the input layer (S130).

The final power consumption estimate, i.e., the final predicted value, is fed back and used in predicting future power consumption.

In the exemplary embodiment of the present invention, it is possible to accurately predict power consumption, adaptively making use of the merits of each prediction technique according to situations, by using the conventional adaptive energy prediction techniques together, then weighted-averaging the values predicted by each technique according to latest accuracy or configuring additional neural networks, and then making a final prediction. Moreover, an error between the final predicted value and an actual measurement and errors between the predicted values from each technique can be fed back and used for the next prediction, thereby allowing more accurate predictions.

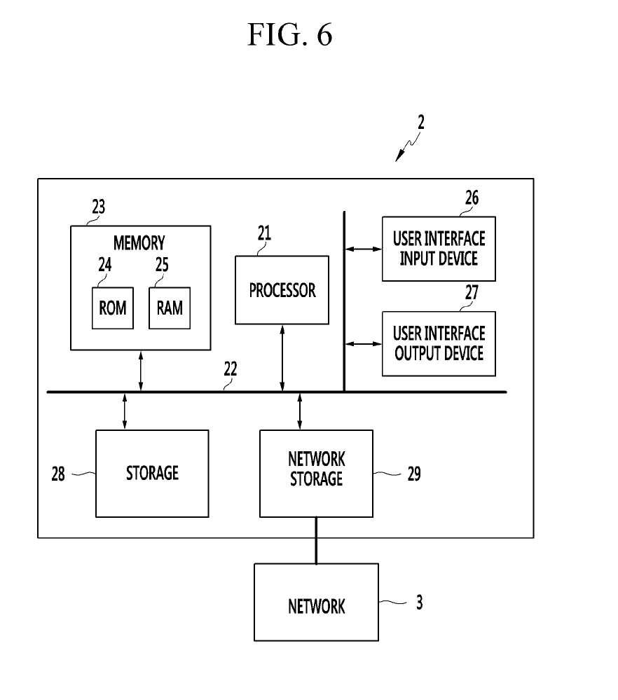

An embodiment of the present invention may be implemented in a computer system, e.g., as a computer readable medium. As shown in in FIG. 6, a computer system 2 may include one or more of a processor 1, a memory 23, a user input device 26, a user output device 27, and a storage 28, each of which communicates through a bus 22. The computer system 2 may also include a network interface 29 that is coupled to a network 3. The processor 21 may be a central processing unit (CPU) or a semiconductor device that executes processing instructions stored in the memory 23 and/or the storage 28. The memory 23 and the storage 28 may include various forms of volatile or non-volatile storage media. For example, the memory may include a read-only memory (ROM) 24 and a random access memory (RAM) 25.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The embodiments of the present invention may not necessarily be implemented only through the foregoing system and/or method, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for predicting power consumption, the method comprising:
using, as first input data, previous measurements, which indicate the actual amount of power consumed in the past, and errors between previous estimates and the previous measurements;
simultaneously calculating power consumption estimates for each prediction technique by using the first input data in at least two prediction techniques;
using, as second data, the power consumption estimates calculated by each prediction technique and errors between the power consumption estimates and an actual measurement; and
predicting the final power consumption by making an additional power consumption prediction based on the second input data.

2. The method of claim 1, wherein the calculating of power consumption estimates for each prediction technique comprises:
predicting power consumption based on the first input data by using an NLMS (normalized least mean square) filter;
predicting power consumption based on the first input data by using a Kalman filter; and
predicting power consumption based on the first input data by using a neural network.

3. The method of claim 1, wherein the predicting of the final power consumption comprises either one of the following:
predicting power consumption based on the second input data by using a weighted average method; and
predicting power consumption based on the second input data by using a neural network.

4. The method of claim 3, wherein, in the predicting of power consumption by using the weighted average method, different weighted values are assigned to the second input data depending on the prediction techniques, and power consumption is predicted based on the second input data to which the different weighted values are assigned.

5. The method of claim 4, wherein the weighted values assigned to the second input data for each prediction technique differ depending on the environmental parameters of an environment where power consumption is predicted.

6. A system for predicting power consumption, the system comprising:
a first layer prediction that uses, as first input data, previous measurements, which indicate the actual amount of power consumed in the past, and errors between previous estimates and the previous measurements, and simultaneously calculates power consumption estimates for each prediction technique by using the first input data in at least two prediction techniques;
an error calculator that calculates errors between the power consumption estimates calculated by each prediction technique and an actual measurement; and
a second layer predictor that uses, as second data, the power consumption estimates calculated by each prediction technique and the errors output from the error calculator, and predicts the final power consumption by making an additional power consumption prediction based on the second input data.

7. The system of claim 6, wherein the first layer predictor comprises:
a first predictor that predicts power consumption based on the first input data by using an NLMS (normalized least mean square) filter;
a second predictor that predicts power consumption based on the first input data by using a Kalman filter; and
a third predictor that predicts power consumption based on the first input data by using a neural network.

8. The system of claim 6, wherein the second layer predictor assigns different weighted values to the second input data depending on the prediction techniques, and predicts power consumption based on the second input data to which the different weighted values are assigned.

9. The system of claim 6, wherein the second layer predictor varies the weighted values assigned to the second input data for each prediction technique depending on the environmental parameters of an environment where power consumption is predicted.

10. The system of claim 6, wherein the second layer predictor predicts power consumption based on the second input data by using a neural network.
